(19) United States
(12) Patent Application Publication
(10) Pub. No.: US 2004/0250202 A1
(43) Pub. Date: Dec. 9, 2004

(54) Electronic awards system and method

(76) Inventor: Emmett Williams, N. Bethesda, MD (US)

Correspondence Address: LEWIS AND ROCA, LLP, 40 N. CENTRAL AVE., PHOENIX, AZ, 85004, US

(21) Appl. No.: 10/456,440

(22) Filed: Jun. 5, 2003

(51) Int. Cl. G06F 15/00

(52) U.S. Cl. 715/513

(57) ABSTRACT

A system and method is described for automating and processing employee award programs in a large organization. The method uses computer-based tools that permit users at different to locations to create an award file, access the file, and act on the file. The system allows flexibility so that the electronic awards system may be adjusted to awards and award criteria and approval that are appropriate for each organization. By accessing the electronic award system, a user, with authorization, can take several actions such as create an award file, view an award, approve an award, and reject an award, request additional information, designate others to review the award, and save an award. The award system is computer based and may be made accessible to employees on, for example, an organization's intranet.

This application claims priority from the US Provisional application entitled “Online Program for Processing Employee Awards,” with Serial number pending and filed on Mar. 18, 2003.

### STATEMENT REGARDING FEDERALLY SPONSORED RESEARCH OR DEVELOPMENT

The invention was made by an agency of the United States government or under a contract with an agency of the United States government, the United States Postal Service (“USPS” or “Postal Service”), an independent establishment of the executive branch of the U.S. government.

### BACKGROUND OF THE INVENTION

1. Field of the Invention

The present invention relates to systems and methods for employee performance awards. More particularly, the present invention relates to an electronic interactive program for processing and tracking grants of employee performance awards.

2. Description of the Related Art

To motivate employees, business institutions have customarily given awards to their employees. The process and the nature of granting an award varies from workplace to workplace. Traditionally a supervisor nominates an employee for an award on the basis of work, achievements, and supporting documents regarding the employee's achievements. The award is then reviewed and approved by the departmental head or other approval committee. The award is then communicated to the Personnel Department which further approves it. An authorization may be forwarded to a financial department for a monetary portion of the award. Typically, the employee's supervisor then announces the award in a departmental ceremony.

However, the development and evolution of the modern work environment has impacted the traditional methods of employee recognition and award. Oftentimes, employee teams work at locations that are remote from one another. Different offices may be in different locations within a city, or even in different cities or countries. It is not uncommon for projects or teams to have staff that work at different locations. The advent and progress of telecommuting, flex hours, or home-based offices further work to separate individual employees who nevertheless share a common enterprise or work project.

Additionally, management structures are increasingly matrix patterned where an individual employee may have more than one report or supervisor. Thus the review and award of an employee may call for input from several individuals, supervisors who may themselves be at different locations.

As work environments, both in physical structures and organizational arrangements, complexify, there arises a need for a new management tool that allows for recognition and award to employees where all appropriate individuals can participate in the process.

Employees and managers in different offices oftentimes suffer from communication disadvantages that “central office” workers may not experience. Further, in larger organizations, it may not be clear to employees the criteria that went into an award decision. Why was employee in city A given an award, while an employee in city B was not awarded? Thus, there also is also a need for a management tool that allows transparency regarding the award process to the award transaction participants.

The pace of modern business is often characterized as fast moving. Many business decisions are facilitated by computers and inter-office communication. Thus, there is a corresponding need for a management tool that accelerates the decision-making process related to employee awards in a manner consistent with contemporary business practices.

Hence there is a need for a management tool that addresses one or more of the above-noted drawbacks. Namely, a management tool is needed that allows participation by multiple individuals, who may be in remote locations from one another, in an award decision. Further, the management tool should provide transparency regarding items such as the award recipient and the criteria supporting the award. Finally, there is a need for a management tool that is compatible with quick, computer-assisted decision making. The present invention addresses one or more of these needs.

### SUMMARY OF THE INVENTION

The present invention provides a business tool to be used in facilitating employee performance awards. The method provides computer-based tools for automating and processing employee award programs. The system and method is well suited to those award programs in a large organization where, for example, employees and supervisors are working at multiple locations. The method uses computer-based tools that permit users at different to locations to create an award file, access the file, and act on the file. The system allows flexibility so that the electronic awards system may be adjusted to awards and award criteria and approval that are appropriate for each organization. By accessing the electronic award system, a user, with authorization, can take several actions such as create an award file, view an award, approve an award, and reject an award, request additional information, designate others to review the award, and save an award. The award system is computer based and may be made accessible to employees on, for example, an organization's intranet.

In one embodiment, the electronic awards system provides a method for electronically preparing and processing employee award information on an organization's computer system. The method includes the following steps: creating a computer-based award profile by selecting an award type from a scroll down menu, entering the recipients social security number; entering the award amount, completing address information for the recipient, designating a finance number, certifying the award information, and selecting an approver. The method then includes providing the award profile to approvers through electronic means; approving the award; and awarding the employee.

In a further embodiment the present invention provides a system for electronically processing employee awards. The system includes a network of linked computers; at least one server linked to said network; and awards software residing on a server wherein the awards software processes employee award information. The system network preferably comprises an intranet within an organization. The awards software provides means to create an award; means to approve an award; means to view an award, and means to provide maintenance for award information. In one embodiment the awares software to create an award further comprises functionality to select an award type from a scroll down menu; to enter the recipients social security number; to enter the award amount; to complete address information for the recipient; to designate a finance number; to certify the award information, to selecting an approver; and to provide the award profile to an approver through electronic means.

The system also preferably includes a database residing on a server wherein the database comprises employee address information, award types, and approver identities.

The system and method is generally described as an electronic awards system. Thus embodiments of the invention may be described herein as the eAwards system.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed. Thus, the present invention comprises a combination of features, steps, and advantages which enable it to overcome various deficiencies of the prior art. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of a preferred embodiment of the present invention, reference will now be made to the accompanying drawings, which form a part of the specification, and wherein:

FIG. 1 is an illustration of the Welcome Page displayed by one embodiment of the present invention.

FIG. 2 is an illustration of the Create Award screen displayed by an embodiment of the present invention.

FIG. 3 is a diagram illustrating the features that certain types of employees are authorized to view in one embodiment.

FIG. 4 is an illustration of the Award Information page displayed by an embodiment of the present inventions.

### DETAILED DESCRIPTION OF THE PREFERRED EMBODIMENT

Reference will now be made in detail to exemplary embodiments of the invention, examples of which are illustrated in the accompanying drawings. Wherever possible, the same reference numbers will be used throughout the drawings to refer to the same or like parts.

According to the invention, an online program has been devised which automates the awards process. An electronic award is based on a participant workflow model.

Participants are 1) designees, 2) submitters, and 3) approvers. Designees may be assigned by submitters to draft awards in their behalf. Submitters are employees eligible by policy to nominate other employees for awards. Approvers are employees eligible by policy to approve an award for eligible employees.

Participants are notified, preferably by email, concerning award events.

Eligible employees, Supervisors and Managers use the eAwards program to enter an award request. The program further allows the award request to be submitted, and for the progress of the request during the approval process to be monitored.

The application uses computer-based software. In a preferred embodiment Oracle Workflow software is the software engine that controls the approval process and email notifications. A software such as Oracle Workflow manages workflow processes, and has the capability to send and receive email messages, and is integrated with an Oracle database.

The program prompts the persons involved to enter the required input at each stage. Users are required to set up a profile which allows users to input information such as their phone number, email address, approver, alternate approver, designee, and a code which will cause the selection of a mailing address for the approved award check.

In the first step to create the award, the recommender opens the program. The program offers a choice of award types including as for example within the United States Postal Service, Special Achievement Award, Meritorious Service Award, Distinguished Service Award, Spot Cash, Spot Cash Equivalent, Spot Non-Cash Tangible, and Team Awards. The recommender makes the desired award type selection.

After having made the award selection, the automated award system calls upon the submitter or recommender to enter certain information related to the award. In a preferred embodiment, the recommender then enters the Social Security Number (SSN) of the recipient. Where the award type includes a cash amount, the recommender is also prompted to enter the award amount. The program also asks the recommender to submit a Basis of Award. The accounting code or appropriate billing information with which to charge or account for the award is also included. Finally the address information for the recipient is submitted so that a check may be mailed to the person receiving the award.

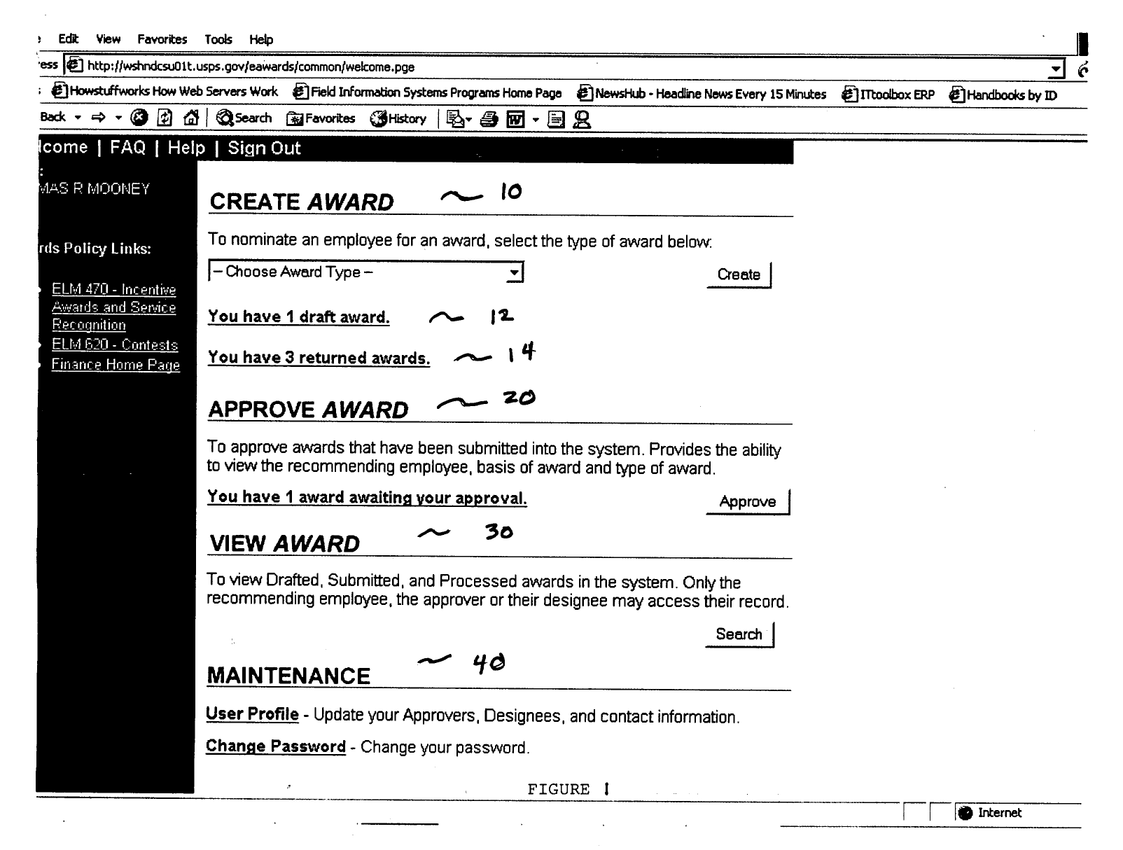

A preferred embodiment of one aspect of the invention is shown in FIG. 1, which represents the Welcome screen displayed by a preferred embodiment of the eAwards system. Screens within the Employee Awards application are preferably divided into four main regions: header, navigation bar, content area, and footer. The header and footer preferably contain links to frequently accessed areas of the application. These are Welcome, FAQ, Help, and Sign Out. Welcome returns you to the Welcome page/Home page. FAQ displays a list of commonly asked questions and their answers. Help provides assistance for the Awards application. And Sign Out logs out of eAwards.

Preferably, the Welcome page or starting point of the eAwards system provides the following options: Create an Award (10), Approve an Award (20), View an Award (30), and Maintenance (40). This is shown in FIG. 1. While this is the preferred starting point of the system, it will be understood by those practiced in the art, that a new user may be directed to this point after first entering and saving user profile information. Likewise, if desired, access to the program may be protected by password requirements.

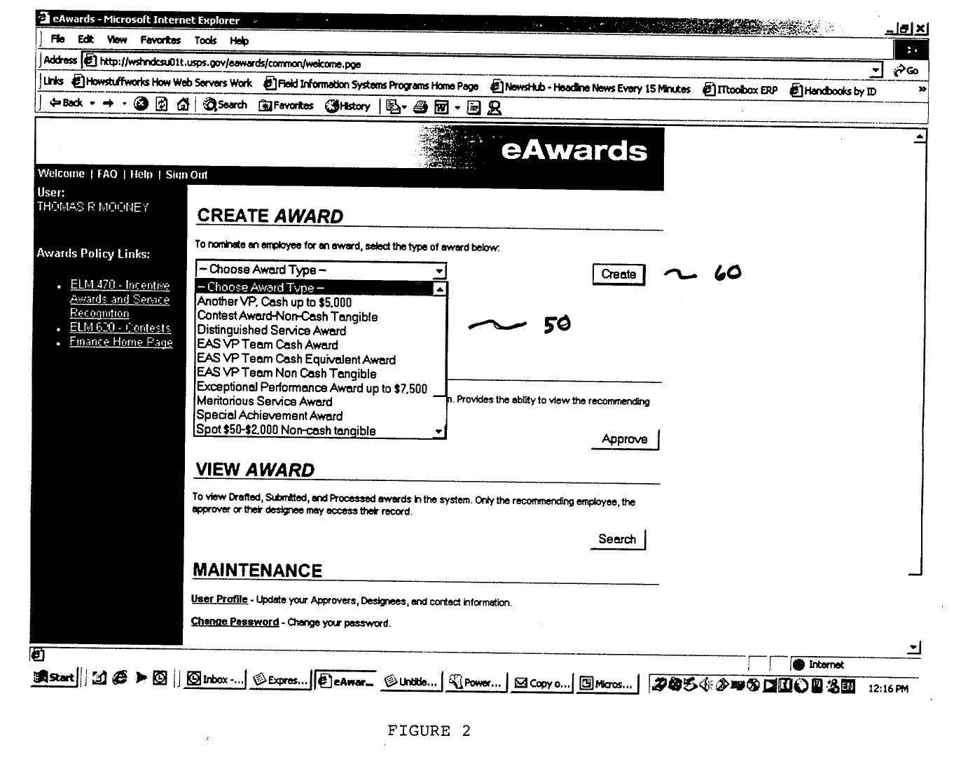

Referring now to FIG. 2, in the logical organization of the eAwards system, a node with several options or decisions is the Create Awards section. This section is where the process of creating any award begins and is visible to Designees, Subitters, Approvers, and System Administrators. The Create Award list option contains a list, preferably a drop down list (50), from which to select the Award Type. After selecting the Award Type, the user clicks Create (60) to access the Award Information Page. At that point the remainder of the information necessary to begin the awards process is entered.

Preferably, when selected, the Create Award page will also display a notice whether the user has any draft awards. Thus as shown in FIG. 1, if the user has a saved draft award, or if a designee has created and saved a draft award, a message such as “You have X draft awards.” (12) will appear. Preferably the message is also a hyperlink so that clicking the link will open a Draft Awards page. At that location the user can select a draft award to view.

If awards have been returned, the eAwards program generates a message, such as “You have X returned awards.” (14) to notify the user. Preferably the message is also a hyperlink so that a list of returned awards are displayed on the Draft Awards page. Selecting an individual award now displays the Award Information page with the comments from the approver why the award is returned.

A user has an option to delete a draft award by, for example, selecting a delete link.

A second node with options for further action is the Approve Awards (20) section. By selecting this option in the eAwards system, several options are displayed. One option is Awards Submitted for Approval. This page returns a list of awards that are currently in submitted status and are awaiting approval by the user. Only those award for which the user is designated as having approval authority appear on that users list of Awards Submitted for Approval. If desired, the user may select the Award Information page for a particular submitted award. Preferably this selection is done in windows based applications by clicking the desired name from the list.

Return to Submitter with Comments is another option in the Approve Award section. Preferably this page opens when the user clicks the return to Submitter with Comments from the Award Information page of an award that is pending approval. On this page a user can enter text explaining why an award is being returned. For example it may be that submitted information is incorrect or because the award is being rejected. Preferably, an email notification will be sent to the submitter stating that the award is being returned. The explanatory text will appear at the bottom of the award information page for the given award.

View Award (30) is another option at the starting point of the eAwards system. Selecting the View Award option moves to a page with further choices. The View Award page includes an award search option. This option links to search software or a search engine that will identify specific awards that match the submitted search criteria. to An award search results displays award records that match the search criteria entered.

Preferably the View Award feature is available to a Submitter, Designee, Approver and Approver's Designee. Once an award has been submitted, the fields on the View Award screen become read only. No changes may be made to the award at that screen. If an award has been drafted but not submitted, the approver should not be able to access the award until submitted.

The Maintenance (40) option located at the Welcome page provides further structural links in the eAwards system. Selecting the Maintenance option displays the suboptions. A first suboption is a User Profile page in which users may enter/update contact information. The User Profile also allows a user to select Designees and Approvers if applicable. Preferably, the Maintenance page also allows selection of an Approver/Altemate Approver Lookup. That page allows a user to look up employees with an eAwards user account who may be selected as a primary or alternative approver for a given award. Similarly there is a Designee Lookup on the Maintenance page. The Designee lookup allows a user to look up employees with an eAwards user account to select as a Designee. Also, preferably, there is a change password option at the Maintenance page.

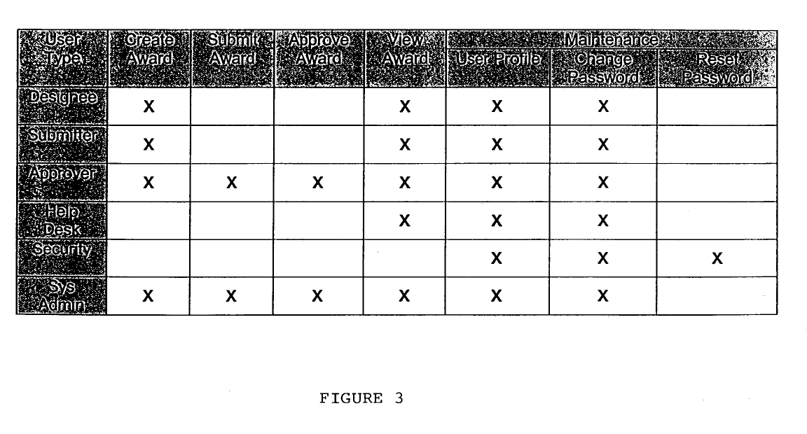

What has been described thus far is the structure of the eAwards system for an employee who has full system privileges. However, it may be, and often is, appropriate to limit access to certain parts of the eAwards system depending on the employee's position within the organization. Thus, in a preferred embodiment, the Welcome page displays a list of options dependent on each user's profile. FIG. 3 indicates which options are displayed for each user type. Further, different user types can have differing privileges for the same option. Also, it is possible for a user to have more than one user type associated with their profile. For example, a user can be selected as both an approver for one user and a designee for another.

An important function of the eAwards system is the process of creating the portion for an award on an Award Information page. Criteria for the awards, depending on the organization, can be built into the eAwards system. These criteria include features such as eligibility requirements, fiscal limits, and a recipient's award history. Additionally, some awards may require approval of employees at a certain organizational level. Preferably the eAwards system alerts a user during the creation process if there is a problem with a proposed award as drafted.

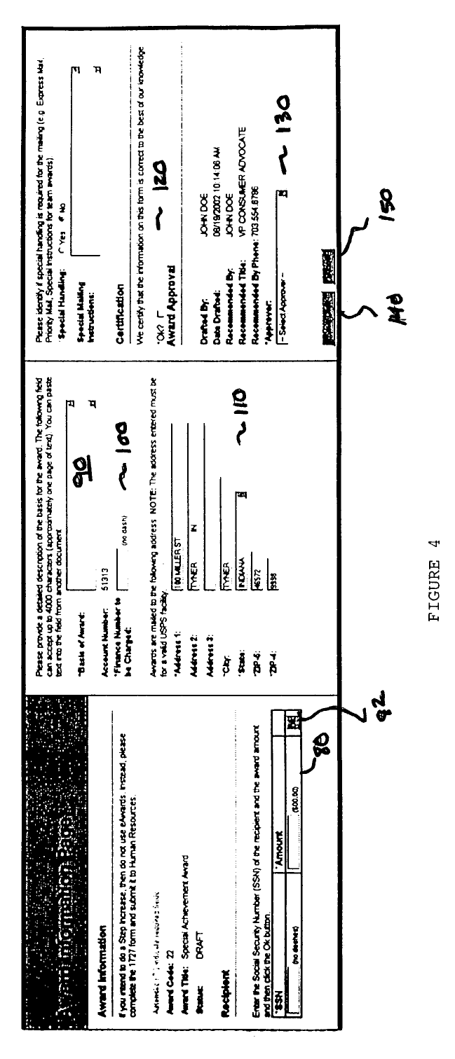

In a preferred embodiment, the Create Award section of the Welcome page includes the following steps in creating an award. Under the Create Award section of the Welcome page, a user selects the type of aware from a drop down list. After making that selection, the user activates a Create function by clicking the Create button. This opens an Award Information page. At that page, shown in FIG. 4 further steps follow. For a team award, the team name is entered. Under the Recipient/Recipients section (80), the user enters the social security number of the recipient and the award amount. The information can be displayed by clicking the OK button (82) which activates that function. After displaying the information, you can add information for additional recipients if necessary. A reason for the basis of the award is entered in the Basis of Award field (90). Preferably, the information can be text pasted from another document, such as a Word document. If the award is a contest award, the Contest Type is selected from a list, such as a drop down list. A Finance Number to account for the charge of the award is entered in the Finance Number field (100). Address information related to the recipient is, preferably, automatically loaded into the address fields (110) once the recipient's social security number is entered. If necessary, the address information that is automatically displayed may be updated and corrected in the address fields. Optionally, there may be displayed a tax liability clause, which must be acknowledged by checking an OK box. Also, optionally, a certification statement (120) may be affirmed by checking an OK box. Optionally, depending on authorization levels for a given award, the Award Information page may also include information for the individual who recommended the award. Finally, an approver may be selected from the list in the approver box (130). A scroll down menu or search function can assist in viewing and selecting an approver.

At this point, the Award Information has been inputted and the user may save a draft by selecting the Save Draft option (140). Additionally, the user can submit the award for processing and approval by activating a submit button (150).

The US Postal Service is an example of one organization that recognizes a number of awards that can be given to its employees. Among the awards recognized in the USPS Employee Relations Manual are Special Achievement Award, Meritorious Service Award, Distinguished Service Award, Spot Cash ($50-$2,000), Spot Cash Equivalent, Spot Non-Cash Tangible ($50-$2,000), VP Own Group, Team Cash Award, Team Cash Equivalent Award, Team Non-Cash Tangible, Exceptional Performance Award (up to $7,000), Contest Award, and Safety Award. It is noted that the eAwards system is suitable for use with teams so that each employee of the team shares in the award. These award types are among those that are built into an eAwards system to be used by the US Postal Service.

Print features may be included to the eAwards software. Thus, for example, an Award Summary or Award Information Page may be printed.

While a variety of software and hardware systems may be used to practice the eAwards system, preferably development tools are selected from the Oracle suite of products. In a preferred embodiment, the database may be an Oracle Database (version 8.1.7). Oracle Workflow may be used to manage workflow processes, provide capability to send and receive email messages, and integrate with an Oracle database. Additionally an Oracle 9I Application Server (9iAS) may be used to manage login and SSL encryption.

Within a given organization, the eAwards system may be integrated into that company's or organization's intranet. Thus, in a preferred embodiment, the eAwards system may be hosted, in part, on an Application Server such as a Sun 4500 which acts as the Oracle 9i Application Server providing JSPs and Java Classes to generate dynamic HTML pages. Also a database server, such as the Sun 4500 may host the Oracle database and include handling of workflow processes and email processes.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims which follow, the scope of which shall include all equivalents of the subject matter of the claims.

What is claimed is:

1. A method for processing employee awards electronically within an organization comprising:
creating a computer-based award profile;
providing the award profile to approvers through electronic means; and
approving the award.

2. The method of claim 1 wherein the step of creating a computer-based award profile further comprises entering recipient information and selecting an approver.

3. The method of claim 1 wherein the step of creating a computer-based award profile further comprises selecting an award type from a scroll down menu.

4. The method of claim 1 further comprising submitting award information.

5. The method of claim 4 wherein the step of submitting award information comprises entering the recipients social security number; entering the award amount, completing address information for the recipient, designating a finance number, certifying the award information, and selecting an approver.

6. The method of claim 1 further comprising submitting the award for processing.

7. The method of claim 1 further comprising reviewing an award by an approver and approving an award by an approver.

8. A method for electronically preparing and processing an employee award file on an organization's computer system comprising:
creating a computer-based award profile by selecting an award type from a scroll down menu entering the recipients social security number; entering the award amount, completing address information for the recipient, designating a finance number, certifying the award information, and selecting an approver;
providing the award profile to approvers through electronic means;
approving the award; and
awarding the employee.

9. The method of claim 8 further comprising saving a draft of award information.

10. The method of claim 8 further comprising selecting an approver through an approver look up function.

11. The method of claim 8 further comprising selecting a designee.

12. The method of claim 11 further comprising selecting a designee through a designee look up function.

13. The method of claim 8 further comprising accessing an employee award profile by providing a password.

14. The method of claim 8 wherein the award types comprise: Special Achievement Award, Meritorious Service Award, Distinguished Service Award, Spot Cash, Spot Cash Equivalent, Spot Non-Cash Tangible, VP Own Group, Team Cash Award, Team Cash Equivalent Award, Team Non-Cash Tangible, Exceptional Performance Award, Contest Award, and Safety Award.

15. The method of claim 8 further comprising displaying a welcome page with options to create an award file, approve an award, view a file, and perform maintenance.

16. A system for electronically processing employee awards comprising:
a network of linked computers;
a server linked to said network;
awards software residing on said server wherein said awards software processes employee award information.

17. The system of claim 16 wherein said network comprises an intranet within an organization.

18. The system of claim 16 wherein said awards software comprises
means to create an award;
means to approve an award;
means to view an award, and
means to provide maintenance for award information.

19. The system of claim 18 wherein said means to create an award further comprises functionality to select an award type from a scroll down menu; to enter the recipients social security number; to enter the award amount; to complete address information for the recipient; to designate a finance number; to certify the award information, to selecting an approver; and to provide the award profile to an approver through electronic means.

20. The system of claim 16 further comprising a database residing on said server wherein said database comprises employee address information, award types, and approver identities.
